(19) United States
(12) Patent Application Publication
(10) Pub. No.: US 2024/0249193 A1
(43) Pub. Date: Jul. 25, 2024

(54) Heterogeneous Federated Learning Via Multi-Directional Knowledge Distillation

(71) Applicant: Google LLC, Mountain View, CA (US)

(72) Inventors: Jared Alexander Lichtarge, Brooklyn, NY (US); Rajiv Mathews, Sunnyvale, CA (US); Rohan Anil, Lafayette, CA (US); Ehsan Amid, Mountain View, CA (US); Shankar Kumar, New York, NY (US)

(21) Appl. No.: 18/417,947

(22) Filed: Jan. 19, 2024

Related U.S. Application Data
(60) Provisional application No. 63/480,832, filed on Jan. 20, 2023.

(51) Int. Cl. G06N 20/00

(52) U.S. Cl. CPC G06N 20/00

(57) ABSTRACT

Generally, the present disclosure is directed to enhanced federated learning (FL) that employs a set of clients with varying amounts of computational resources (e.g., system memory, storage, and processing bandwidth). To overcome limitations of conventional FL methods that employ a set of clients with varying amounts of computational resources, the embodiments run multi-directional knowledge distillation between the server models produced by each federated averaging (FedAvg) pool, using unlabeled server data as the distillation dataset. By co-distilling the two (or more) models frequently over the course of FedAvg rounds, information is shared between the pools without sharing model parameters. This leads to increased performance and faster convergence (in fewer federated rounds).

### PRIORITY CLAIM

The present application claims priority to U.S. Provisional Application No. 63/480,832, entitled “HETEROGENEOUS FEDERATED LEARNING VIA MULTI-DIRECTIONAL KNOWLEDGE DISTILLATION,” filed on Jan. 20, 2023, the contents of which are herein incorporated in their entirety.

### FIELD

The present disclosure relates generally to federated learning. More particularly, the present disclosure relates to heterogeneous federated learning via multi-directional knowledge distillation.

### BACKGROUND

Conventional federated learning (FL) allows a decentralized and diverse pool of clients to learn a single shared model without sharing private data. Conventional FL is typically accomplished via federated averaging (FedAvg), which merges model differences from a set of clients in each round to produce a single update step on the shared server model. Averaging model updates from clients require that all clients (from the merging set) share the same architecture. As the client pool is composed of diverse hardware with varying capacity for model training, sharing an architecture requires all clients, regardless of capacity, to use the lowest-common-denominator model size. Using the lowest-common-denominator models on hardware that could support training larger models leads to lower performance than if all clients could use their maximum capacity.

Rather than having both high- and low-capacity clients share a model, some conventional FL methods partition the set of clients into two (or more) pools, sorted by model-size capacity, and run FedAvg independently within each pool. However, these conventional FL methods silo information from the two (or more) groups, which decreases model performance and introduces bias (e.g., the larger model sees more data from more advanced phones).

Bi-directional knowledge distillation [2] between the server models produced by each FedAvg pool, using unlabeled server data as the distillation dataset. By co-distilling the two (or more) models frequently over the course of FedAvg rounds, we can share information between the pools without sharing model parameters. This can lead to increased performance and faster convergence (in fewer federated rounds

### SUMMARY

Aspects and advantages of embodiments of the present disclosure will be set forth in part in the following description, or can be learned from the description, or can be learned through practice of the embodiments.

One example aspect of the present disclosure is directed to heterogeneous federated learning performed via multi-directional knowledge distillation. In one non-limiting embodiment, a computing system accesses a set of server models. The set of server models includes at least a first server model and a second server model. Each server model of the set of server model has a one-to-one correspondence with a separate client-device subset of a plurality of client-device subsets. The plurality of client-device subsets includes at least a first client-device subset corresponding to the first server model and a second client-device subset corresponding to the second server model. Each client-device subset of the plurality of client-device subsets may be a subset of a set of client devices and is disjoint from each other client device subset of the plurality of client-device subsets. The computing system may access a set of distillation training data. The computing system may update the second server model via a first knowledge distillation process based on the set of distillation training data. The first server model may be employed as a teacher model of the first knowledge distillation process. The second server model may be employed as a student model of the first knowledge distillation process. The computing system may cause a transmission of the updated second server model to at least a first portion of client devices of the second client-device subset.

Another example aspect of the present disclosure, the computing system may update the first server model via a second knowledge distillation process based on the set of distillation training data. The second server model may be employed as a teacher model of the second knowledge distillation process. The first server model may be employed as a student model of the second knowledge distillation process. The computing system may cause a transmission of the updated first server model to at least a first portion of client devices of the first client-device subset.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs heterogeneous federated learning according to example embodiments of the present disclosure.

FIG. 1B depicts a block diagram of an example computing device that performs heterogeneous federated learning according to example embodiments of the present disclosure.

FIG. 1C depicts a block diagram of an example computing device that performs heterogeneous federated learning according to example embodiments of the present disclosure.

FIG. 2 depicts a flow chart diagram of an example method to perform heterogenous federated learning according to example embodiments of the present disclosure.

FIG. 3 depicts a flow chart diagram of another example method to perform heterogenous federated learning according to example embodiments of the present disclosure.

Reference numerals that are repeated across plural figures are intended to identify the same features in various implementations.

### DETAILED DESCRIPTION

### Overview

Generally, the present disclosure is directed to enhanced federated learning (FL) that employs a set of clients with varying amounts of computational resources (e.g., system memory, storage, and processing bandwidth). To overcome the above-discussed limitations of conventional FL methods that employ a set of clients with varying amounts of computational resources, the embodiments run bi-directional knowledge distillation between the server models produced by each federated averaging (FedAvg) pool, using unlabeled server data as the distillation dataset. By co-distilling the two (or more) models frequently over the course of FedAvg rounds, information is shared between the pools without sharing model parameters. This can lead to increased performance and faster convergence (in fewer federated rounds).

In one embodiment, a computing system accesses a set of server models. The set of server models includes at least a first server model and a second server model. Each server model of the set of server model has a one-to-one correspondence with a separate client-device subset of a plurality of client-device subsets. The plurality of client-device subsets includes at least a first client-device subset corresponding to the first server model and a second client-device subset corresponding to the second server model. Each client-device subset of the plurality of client-device subsets may be a subset of a set of client devices and is disjoint from each other client device subset of the plurality of client-device subsets. The computing system may access a set of distillation training data. The computing system may update the second server model via a first knowledge distillation process based on the set of distillation training data. The first server model may be employed as a teacher model of the first knowledge distillation process. The second server model may be employed as a student model of the first knowledge distillation process. The computing system may cause a transmission of the updated second server model to at least a first portion of client devices of the second client-device subset.

Aspects of the present disclosure provide a number of technical effects and benefits. For instance, information is shared between the client device subsets without sharing model parameters. Rather than having both high- and low-capacity clients share a model, the embodiments partition the set of clients into two (or multiple) pools, sorted by model-size capacity, and run FedAvg independently within each pool. The embodiments avoid isolating information from the two groups, which conventional methods do. Isolating information in the two groups hurts model performance and introduces bias (e.g., the larger model sees more data from more advanced phones). Thus the embodiments provide increased performance and faster convergence (in fewer federated rounds).

With reference now to the Figures, example embodiments of the present disclosure will be discussed in further detail.

### Example Devices and Systems

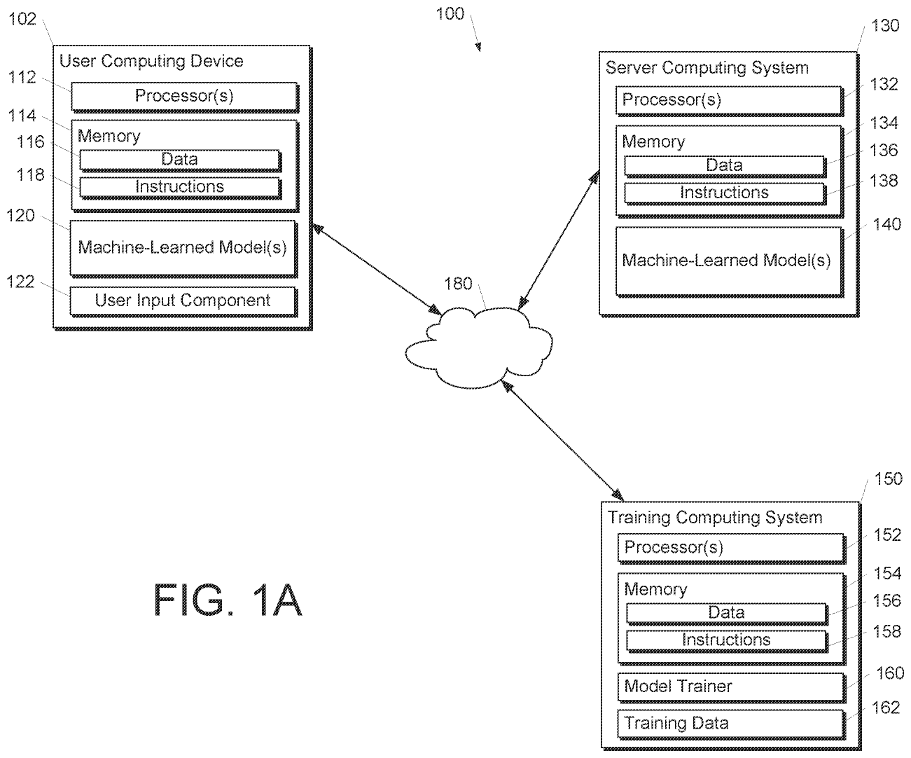

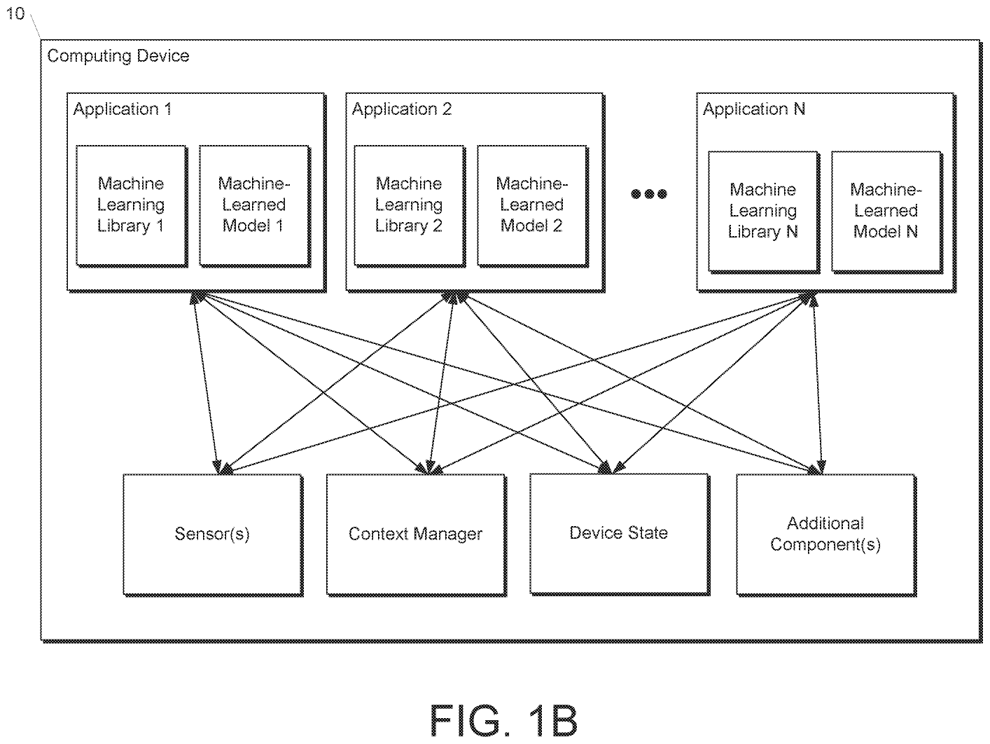

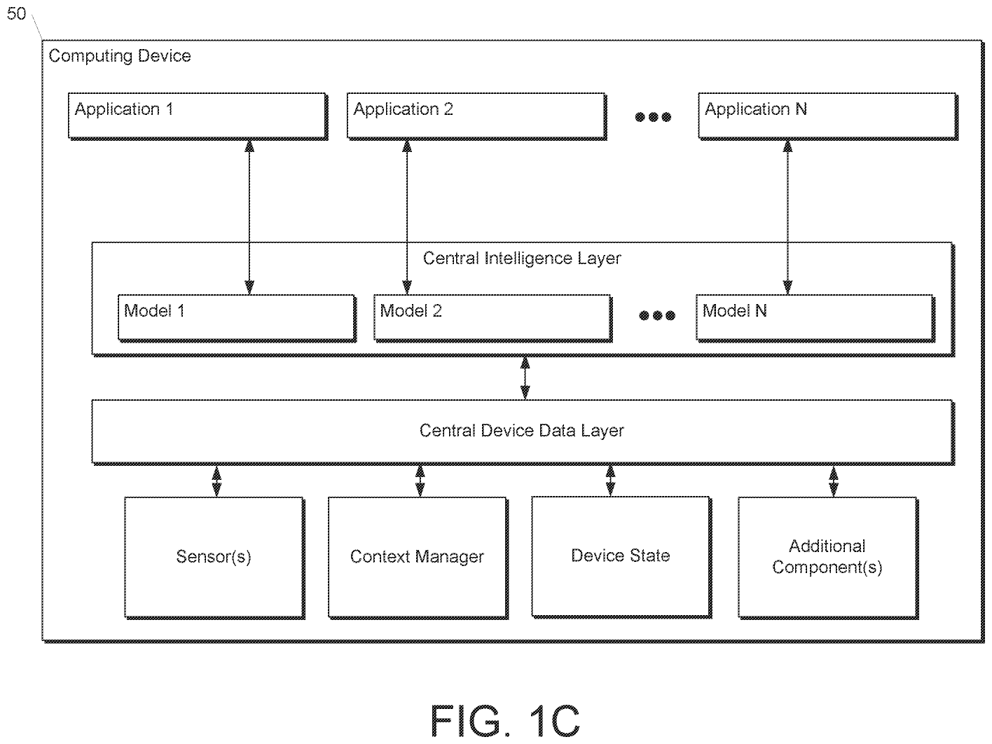

FIG. 1A depicts a block diagram of an example computing system 100 that performs heterogeneous federated learning according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service. Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example,

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Methods

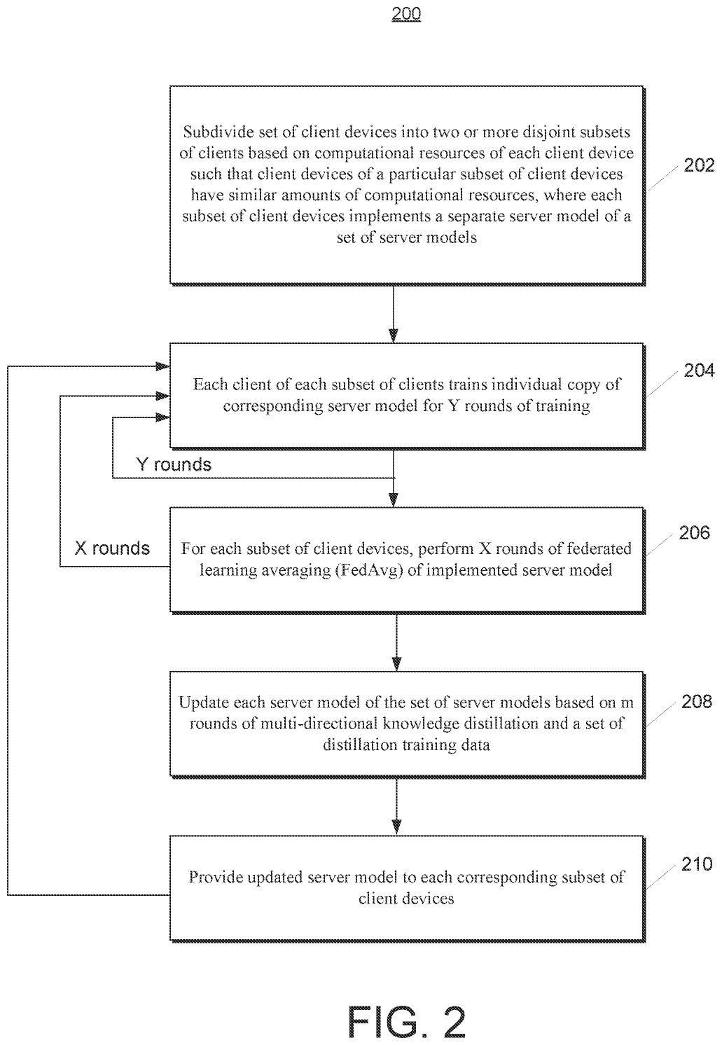

FIG. 2 depicts a flow chart diagram of an example method 200 to perform heterogenous federated learning according to example embodiments of the present disclosure. Although FIG. 2 depicts steps performed in a particular order for purposes of illustration and discussion, the methods of the present disclosure are not limited to the particularly illustrated order or arrangement. The various steps of the method 200 can be omitted, rearranged, combined, and/or adapted in various ways without deviating from the scope of the present disclosure.

For the embodiments (including method 200), the conventional constraint on federated learning that all clients must share the same model architecture is relaxed. The relaxation of this constraint is enabled by splitting (e.g., subdividing or clustering) the client pool (e.g., a set of client devices) into two (or more) sub-pools (e.g. subsets or clusters of client devices) based on hardware constraints (e.g., amounts of computational resources associated with each sub-pool) and model sizes (e.g., server models of a set of server models). Federated averaging (FedAvg) is performed within each sub-pool (or subset). The separate server models (e.g., a separate server model implemented by each sub-pool) are periodically synced via multi-directional knowledge distillation process. The embodiments split (e.g., subdivide or cluster) the pool of all clients into two (or more) partitions based on the max model parameters each client is capable of training. The discussion of method 200 is directed to an embodiments that employs separate knowledge distillation updates. Another embodiment is discussed after the main discussion of method 200 that merges updated according to FedAvg updates and knowledge distillation updates. In the main discussion of method 200, knowledge distillation is applied independently of the federated averaging process. In the main discussion of method 200, each direction of knowledge distillation is run for positive integer m steps (e.g., via a teach/student model knowledge distillation process), where the updates are employed in the next round of training. In the FedAvg training rounds, each server model is updated according to the average of the model updates of their respective pools.

At 202, a computing system may subdivide set of client devices into two or more disjoint subsets of clients based on computational resources of each client device. The subdividing, pooling, and/or clustering of the client devices may be such that client devices of a particular subset of client devices have similar amounts of computational resources. Each subset of client devices implements a separate server model of a set of server models. Each client device of a particular subset of client devices may implement a separate copy of the server model that corresponds to the particular subset of devices. Thus, the number of server models may be equivalent (or at least similar) to the number of disjoint subsets of client devices.

The following discussion is directed towards a non-limiting embodiment where the subdividing of the client devices results in two subsets of client devices (e.g., a first subset and a second subset of client devices. The first subset of client devices may implement a first server model (e.g., Θ) of the set of server models and the second subset of devices may implement a second server model (e.g., Ψ) of the set of server models. The client devices of the first subset of client devices may have larger amounts of computational resources than the client devices of the second subset of client devices. Thus, the client devices of the first subset of client devices may be enabled to implemented larger (or more complicated) server models than the client devices of the second subset of client devices. Thus, the first server model (e.g., Θ) may be a larger (or more complicated) model than the second server model (e.g., Ψ). Without referring to the performance of either model, the first server model may be referred to as the main model and the second server model may be referred to as the auxiliary model. Note that method 200 iteratively trains each server model of the set of server models. Thus, the iterated updating of each model is referred to via a non-negative integer (e.g., t) superscript on the model (e.g., Θ^{t} and Ψ^{t}). It should be noted that although the discussion is directed to a non-limiting case of two subsets (e.g., pools or clusters) of client devices, the embodiments are not so limited, and the embodiments may be generalized to any number (greater than one) of subsets of client devices (and server models).

At block 204, each client of each subset of clients trains their individual copy of corresponding server model for Y rounds of training, where Y is a positive integer, as indicated by the feedback arrow marked with “Y rounds.” After Y rounds on training their separate copies of the corresponding server model, the client devices may provide their updated copies of the corresponding server model to a centralized server device that is responsible for performing the FedAvg process.

At block 206, for each subset of client devices, X (e.g., where X is a positive integer) rounds of federated learning averaging (FedAvg) of the implement ed server model are performed for each subset of client devices. After a single round of the FedAve process, the averaged server models may be provided back to the respective clients, as indicated by the feedback arrow marked as “X rounds”.

At block 208, each server model of the set of server models is updated based on m (e.g., where m is a positive integer) rounds of multi-directional knowledge distillation and a set of distillation training data. The set of distillation training data may be referred to a D, which may be unlabeled training data. More particularly, for the last round of block 206 (within a single iteration of the “outer” loop of method 200), the two server models may be updated from (Θ^{t}, Ψ^{t}) to (Θ^{t+1}, Ψ^{t+1}) via a FedAvg step. Thus, block 208 may receive the models (Θ^{t+1}, Ψ^{t+1}).

For each of the m rounds of knowledge distillation of block 208, the first server model may be used as a teaching model and the second server model may be used as a student model for updating. Separate, the second model may be used as a teaching model and the first server model may be employed as the student model. This alternating between student/teaching model assignments may be run in parallel or in serial mode.

When the first server model is employed as a teacher mode (and the second server model is employed as the student model), soft labeled logits of Θ^{t+1} may be calculated over D to generate a first soft-label distillation dataset (D_{Θ}). The first soft-label distillation dataset may be referred to as the main soft-label distillation dataset. Likewise, when the second server model is employed as a teacher mode (and the first server model is employed as the student model), soft labeled logits of Ψ^{t+1} may be calculated over D to generate a second soft-label distillation dataset (D_{Ψ}). The second soft-label distillation dataset may be referred to as the auxiliary soft-label distillation dataset.

As the student model, the first server model may be updated (starting from Θ^{t+1}) on D_{Ψ} for steps using a relative entropy loss between predictions of Θ and D_{Ψ}, to update the first server model to Θ^{t+1+m}. Likewise, as the student model, the second server model may be updated (starting from Ψ^{t+1}) on D_{Θ} for steps using a relative entropy loss between predictions of Ψ and D_{Θ}, to update the second server model to Ψ^{t+1+m}.

At block 210, the updated models (Θ^{t+1+m}, Ψ^{t+1+m}) to the client devices of their corresponding subset of client devices. Method 200 may return to block 204 (via the outer loop of method 200) for additional training.

In an additional embodiment related to method 200, during co-distillation rounds (which still occur with frequency X, as before), a single model update may be merged from FedAvg with a single model update calculated from the difference between each student model at the start of distillation and the final distilled model. The difference with this additional embodiment, which merges FedAvg and distillation updates is as follows. Rather than starting the next round of updates with (Θ^{t+1}, Ψ^{t+1}) set to (Θ^{t+m}, Ψ^{t+m}), model differences (e.g., model gradients) may be calculated as follows:

$$∇ {Θ}_{Dist}^{t} = {Θ}^{t} - {Θ}^{t + m}$$

$$∇ {Ψ}_{Dist}^{t} = {Ψ}^{t} - {Ψ}^{t + m}$$

For each server model, these model different are merged with the gradients generated during the FedAvg round, with hyperparameter γ controlling the relative contribution to the next model update as follows:

$${Θ}^{t + 1} = {Θ}^{t} - η ( γ * ∇ {Θ}_{FedAvg}^{t} + ( 1 - γ ) * ∇ {Θ}_{Dist}^{t} )$$

$${Ψ}^{t + 1} = {Ψ}^{t} - η ( γ * ∇ {Ψ}_{FedAvg}^{t} + ( 1 - γ ) * ∇ {Ψ}_{Dist}^{t} )$$

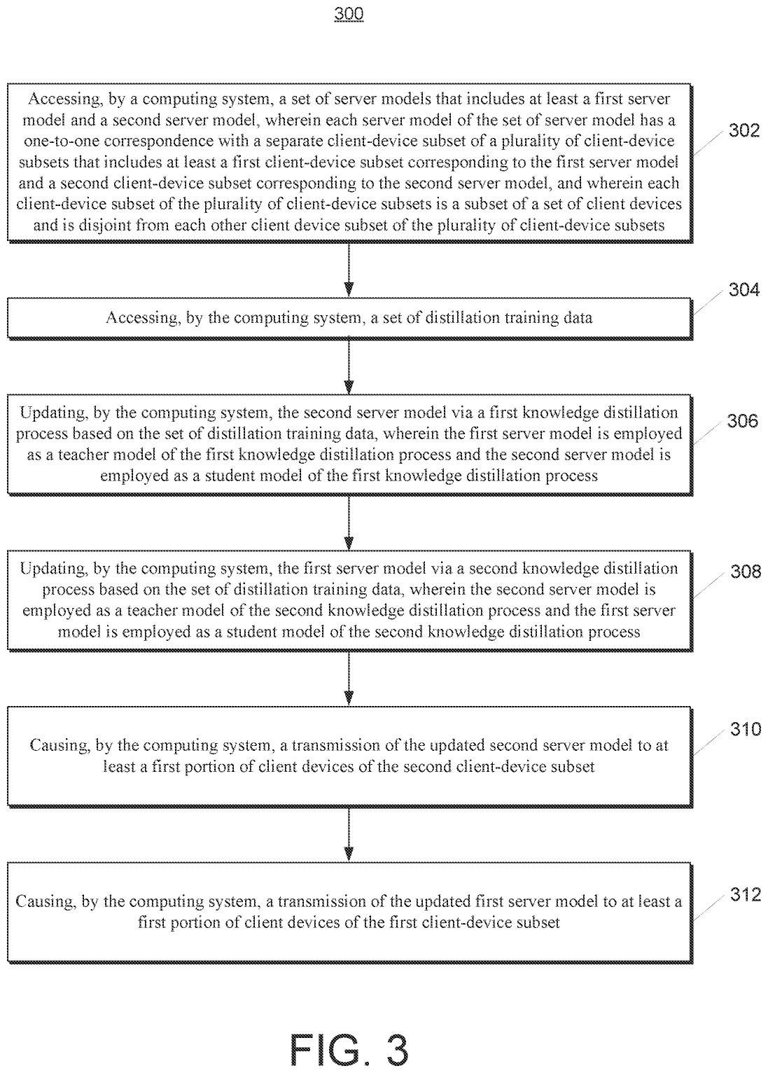

FIG. 3 depicts a flow chart diagram of another example method 300 to perform heterogenous federated learning according to example embodiments of the present disclosure. Method 300 begins at block 302, where a computing system accesses a set of server models that includes at least a first server model (e.g., Θ) and a second server model (e.g., Ψ). Each server model of the set of server model may have a one-to-one correspondence with a separate client-device subset of a plurality of client-device subsets. The plurality of client-device subsets includes at least a first client-device subset corresponding to the first server model and a second client-device subset corresponding to the second server model. Each client-device subset of the plurality of client-device subsets is a subset of a set of client devices and is disjoint from each other client device subset of the plurality of client-device subsets.

In some non-limiting embodiments, the first server model may be encoded via a first set of parameters. Accessing the set of server models may include the computing system accessing a set of client-level values for the first set of parameters for each client device of the first client-device subset. The computing system may determine a first set of server-level values for the first set of parameters based on a federated averaging (FedAvg) process applied to the set of server-level values for the first set of parameters for each client device of the first client-device subset.

The second server model may be encoded via a second set of parameters. Accessing the set of server models may also include the computing system accessing a set of client-level values for the second set of parameters for each client device of the second client-device subset. The computing system may further determine a first set of server-level values for the second set of parameters based on a federated averaging process applied to the set of server-level values for the second set of parameters for each client device of the second client-device subset.

At block 304, the computing system may access a set of distillation training data (e.g., D).

At block 306, the second server model may update the second server model via a first knowledge distillation process based on the set of distillation training data. In the first knowledge distillation process, the first server model may be employed as a teacher model of the first knowledge distillation process and the second server model may be employed as a student model of the first knowledge distillation process.

The first knowledge distillation process may include the computing system generating a first set of predictions (e.g., D_{Θ}) of the first server model based on the set of distillation training data and the first server model. Generating the first set of predictions of the first server model/may include the computing system generating a first probability distribution for a set of labels based on the first server model and the set of distillation training data. The set of labels may be associated with each of the first server model and the second server model. The computing system may generate a second set of predictions (for the second server model) based on the set of distillation training data and the second server model. Generating the second set of predictions for the second server model may include the computing system generating a second probability distribution for the set of labels based on the second server model and the set of distillation training data. The computing system may determine a first performance metric for the second server model based on a comparison of the first set of predictions and the second set of predictions. The first performance metric for the second server model may include a relative entropy loss between the first probability distribution and the second probability distribution. The computing system may update the second server model based on the first performance metric for the second server model.

In some embodiments, the first knowledge distillation process may further and/or alternatively include the computing system implementing the teacher model based on the first set of server-level values for the first set of parameters (e.g., the values for the first set of parameters after the FedAvg update of the first server model). The computing system may implement the student model based on the first set of server-level values for the second set of parameters (e.g., the values for the second set of parameters after the FedAvg update of the second server model). The computing system may generate a first set of labeled training data based on the set of distillation training data. The labels for the first set of labeled training data may be determined based on logits calculated by the teacher model (e.g., the FedAvg′ed updated first server model). The computing system may determine a second set of server-level values for the second set of parameters based on a supervised learning process and the first set of labeled training data. The computing system may update the second server model such that the second set of parameters are encoded by the second set of server-level values for the second set of parameters.

At block 308, the computing system may update the first server model via a second knowledge distillation process based on the set of distillation training data. In the second knowledge distillation process, the second server model may be employed as a teacher model of the second knowledge distillation process and the first server model may be employed as a student model of the second knowledge distillation process.

The second knowledge distillation process may include the computing system generating a first set of predictions (e.g., D_{Ψ}) of the second server model based on the set of distillation training data and the second server model. Generating the first set of predictions of the second server model may include the computing system generating a first probability distribution for a set of labels based on the second server model and the set of distillation training data. The set of labels may be associated with each of the first server model and the second server model. The computing system may generate a second set of predictions (for the first server model) based on the set of distillation training data and the second server model. Generating the second set of predictions for the first server model may include the computing system generating a second probability distribution for the set of labels based on the second server model and the set of distillation training data. The computing system may determine a first performance metric for the first server model based on a comparison of the first set of predictions (for the second server model) and the second set of predictions (for the first server model). The first performance metric for the first server model may include a relative entropy loss between the first probability distribution and the second probability distribution. The computing system may update the first server model based on the first performance metric for the first server model.

As noted, the first server model may be updated by the second knowledge distillation process based on the set of distillation training data. In the second knowledge distillation process, the second server model is employed as a teacher model of the second knowledge distillation process and the first server model is employed as a student model of the second knowledge distillation process. That is, the computing system may implement the teacher model based on the first set of server-level values for the second set of parameters and implement the student model based on the first set of server-level values for the first set of parameters.

The second knowledge distillation process may further and/or alternatively include the computing system generating a first set of labeled training data based on the set of distillation training data. The labels for the first set of labeled training data may be determined based on logits calculated by the teacher model. The computing system may determine a second set of server-level values for the first set of parameters based on a supervised learning process and the first set of labeled training data. The computing system may update the first server model such that the first set of parameters are encoded by the second set of server-level values for the first set of parameters.

At block 310, the computing system may cause a transmission of the updated second server model to at least a first portion of client devices of the second client-device subset.

At block 312, the computing system may cause a transmission of the updated first server model to at least a first portion of client devices of the second client-device subset

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method comprising:
accessing, by a computing system, a set of server models that includes at least a first server model and a second server model, wherein each server model of the set of server model has a one-to-one correspondence with a separate client-device subset of a plurality of client-device subsets that includes at least a first client-device subset corresponding to the first server model and a second client-device subset corresponding to the second server model, and wherein each client-device subset of the plurality of client-device subsets is a subset of a set of client devices and is disjoint from each other client device subset of the plurality of client-device subsets;
accessing, by the computing system, a set of distillation training data;
updating, by the computing system, the second server model via a first knowledge distillation process based on the set of distillation training data, wherein the first server model is employed as a teacher model of the first knowledge distillation process and the second server model is employed as a student model of the first knowledge distillation process; and
causing, by the computing system, a transmission of the updated second server model to at least a first portion of client devices of the second client-device subset.

2. The computer-implemented method of claim 1, wherein the first knowledge distillation process comprises:
generating, by the computing system, a first set of predictions based on the set of distillation training data and the first server model;
generating, by the computing system, a second set of predictions based on the set of distillation training data and the second server model;
determining, by the computing system, a first performance metric for the second server model based on a comparison of the first set of predictions and the second set of predictions; and
updating, by the computing system, the second server model based on the first performance metric for the second server model.

3. The computer-implemented method of claim 2, wherein generating the first set of predictions comprises:
generating, by the computing system, a first probability distribution for a set of labels based on the first server model and the set of distillation training data, wherein the set of labels is associated with each of the first server model and the second server model.

4. The computer-implemented method of claim 3, wherein generating the second set of predictions comprises:
generating, by the computing system, a second probability distribution for the set of labels based on the second server model and the set of distillation training data.

5. The computer-implemented method of claim 4, wherein the first performance metric for the second server model includes a relative entropy loss between the first probability distribution and the second probability distribution.

6. The computer-implemented method of claim 1, further comprising:
updating, by the computing system, the first server model via a second knowledge distillation process based on the set of distillation training data, wherein the second server model is employed as a teacher model of the second knowledge distillation process and the first server model is employed as a student model of the second knowledge distillation process; and
causing, by the computing system, a transmission of the updated first server model to at least a first portion of client devices of the first client-device subset.

7. The computer-implemented method of claim 6, wherein the second knowledge distillation process comprises:
generating, by the computing system, a first set of predictions based on the set of distillation training data and the second server model;
generating, by the computing system, a second set of predictions based on the set of distillation training data and the first server model;
determining, by the computing system, a first performance metric for the first server model based on a comparison of the first set of predictions and the second set of predictions; and
updating, by the computing system, the first server model based on the first performance metric for the first server model.

8. The computer-implemented method of claim 7, wherein generating the first set of predictions comprises:
generating, by the computing system, a first probability distribution for a set of labels based on the second server model and the set of distillation training data, wherein the set of labels is associated with each of the first server model and the second server model.

9. The computer-implemented method of claim 8, wherein generating the second set of predictions comprises:
generating, by the computing system, a second probability distribution for the set of labels based on the first server model and the set of distillation training data.

10. The computer-implemented method of claim 1, wherein the first server model is encoded via a first set of parameters and accessing the set of server models comprises:
accessing, by the computing system, a set of client-level values for the first set of parameters for each client device of the first client-device subset; and
determining, by the computing system, a first set of server-level values for the first set of parameters based on a federated averaging process applied to the set of server-level values for the first set of parameters for each client device of the first client-device subset.

11. The computer-implemented method of claim 10, wherein the second server model is encoded via a second set of parameters and accessing the set of server models further comprises:
accessing, by the computing system, a set of client-level values for the second set of parameters for each client device of the second client-device subset; and
determining, by the computing system, a first set of server-level values for the second set of parameters based on a federated averaging process applied to the set of server-level values for the second set of parameters for each client device of the second client-device subset.

12. The computer-implemented method of claim 11, wherein the first knowledge distillation process comprises:
implementing, by the computing system, the teacher model based on the first set of server-level values for the first set of parameters; and
implementing, by the computing system, the student model based on the first set of server-level values for the second set of parameters.

13. The computer-implemented method of claim 12, wherein the first knowledge distillation process further comprises:
generating, by the computing system, a first set of labeled training data based on the set of distillation training data, wherein labels for the first set of labeled training data are determined based on logits calculated by the teacher model; and
determining, by the computing system, a second set of server-level values for the second set of parameters based on a supervised learning process and the first set of labeled training data; and
updating, by the computing system, the second server model such that the second set of parameters are encoded by the second set of server-level values for the second set of parameters.

14. The computer-implemented method of claim 11, further comprising:
updating, by the computing system, the first server model via a second knowledge distillation process based on the set of distillation training data, wherein the second server model is employed as a teacher model of the second knowledge distillation process and the first server model is employed as a student model of the second knowledge distillation process; and
causing, by the computing system, a transmission of the updated first server model to at least a first portion of client devices of the first client-device subset.

15. The computer-implemented method of claim 14, wherein the second knowledge distillation process comprises:
implementing, by the computing system, the teacher model based on the first set of server-level values for the second set of parameters; and
implementing, by the computing system, the student model based on the first set of server-level values for the first set of parameters.

16. The computer-implemented method of claim 15, wherein the second knowledge distillation process further comprises:
generating, by the computing system, a first set of labeled training data based on the set of distillation training data, wherein labels for the first set of labeled training data are determined based on logits calculated by the teacher model; and
determining, by the computing system, a second set of server-level values for the first set of parameters based on a supervised learning process and the first set of labeled training data; and
updating, by the computing system, the first server model such that the first set of parameters are encoded by the second set of server-level values for the first set of parameters.

17. The computer-implemented method of claim 1, updating the second server model comprises:
computing, by the computing system, a gradient of the second server model.

18. A computing system comprising:
one or more processors; and
one or more non-transitory computer-readable media that store instructions that when executed by the one or more processors, cause the computer system to perform operations comprising:
accessing, by the computing system, a set of server models that includes at least a first server model and a second server model, wherein each server model of the set of server model has a one-to-one correspondence with a separate client-device subset of a plurality of client-device subsets that includes at least a first client-device subset corresponding to the first server model and a second client-device subset corresponding to the second server model, and wherein each client-device subset of the plurality of client-device subsets is a subset of a set of client devices and is disjoint from each other client device subset of the plurality of client-device subsets;
accessing, by the computing system, a set of distillation training data;
updating, by the computing system, the second server model via a first knowledge distillation process based on the set of distillation training data, wherein the first server model is employed as a teacher model of the first knowledge distillation process and the second server model is employed as a student model of the first knowledge distillation process; and
causing, by the computing system, a transmission of the updated second server model to at least a first portion of client devices of the second client-device subset.

19. The computing system of claim 18, wherein the first knowledge distillation process comprises:
generating, by the computing system, a first set of predictions based on the set of distillation training data and the first server model;
generating, by the computing system, a second set of predictions based on the set of distillation training data and the second server model;
determining, by the computing system, a first performance metric for the second server model based on a comparison of the first set of predictions and the second set of predictions; and
updating, by the computing system, the second server model based on the first performance metric for the second server model.

20. The computing system of claim 19, wherein generating the first set of predictions comprises:
generating, by the computing system, a first probability distribution for a set of labels based on the first server model and the set of distillation training data, wherein the set of labels is associated with each of the first server model and the second server model.
